(19) United States
(12) Patent Application Publication
(10) Pub. No.: US 2020/0070015 A1
(43) Pub. Date: Mar. 5, 2020

(54) AUTONOMOUS GOLF BALL PICKING SYSTEM

(71) Applicant: Xiaoshi Zhang, Coquitlam (CA)

(72) Inventor: Xiaoshi Zhang, Coquitlam (CA)

(21) Appl. No.: 16/558,233

(22) Filed: Sep. 2, 2019

Related U.S. Application Data
(60) Provisional application No. 62/726,410, filed on Sep. 3, 2018.

(51) Int. Cl. A63B 47/02; G05D 1/02; B60L 53/66

(52) U.S. Cl. CPC A63B 47/021; G05D 1/0214; A63B 2047/022; B60L 53/66; G05D 1/0225

(57) ABSTRACT

An autonomous golf ball picking system configured to pick up golf balls from an outdoor environment. The system includes a route map defining a path to pick up golf balls from the ground. The route map is in a computer readable format. An unmanned ground vehicle having a base unit having an internal ball retention compartment, a ball picking roller configured to pick up golf balls from the ground and to deposit the picked-up golf balls into the internal ball retention compartment, at least two linked wheels, each of the at least two linked wheels driven by an independent motor and configured to move the unmanned ground vehicle around the ground, a battery to provide power to the unmanned ground vehicle, and an unmanned ground vehicle computer system. The computer system is capable of reading the route map and sending directional instructions to the independent motors in order to drive the unmanned ground vehicle along the path set out according to the route map. The system further includes a docking station configured to receive the unmanned ground vehicle upon completion of picking up golf balls according to the route map. The docking station having a golf ball receiving bin configured to receive the picked golf balls from the internal ball retention compartment and to recharge the vehicle's battery.

### REFERENCE TO PENDING APPLICATIONS

This application claims the benefit of U.S. Provisional Patent Application, Ser. No. 62/726,410, entitled Autonomous Golf Ball Picker and filed Sep. 3, 2018.

### BACKGROUND OF THE INVENTION

### 1. Field of the Invention

The present invention relates generally to the field of golf ball picking systems, and more specifically, to an autonomous golf ball picking system.

### 2. Description of the Related Art

In a golf driving range, the current type of golf ball picker, typically requires the manual pushing of a golf ball picking machine or the driving of a human-operated tractor, both of which requires a great amount of human labor. This activity subjects the human operator to heat from the sun during the hot portions of the summer months. Further, the due to the weight of the tractor, the picking up of the golf balls is usually suspended during rain so as not to damage of the grass.

The prior art has attempted to create systems to address these issues. US20100250024A1 entitled Fully Autonomous Or Remotely Operated Golf Ball Picking System discloses a motorised system with electric traction with computer vision for outdoor environments, which can interact with the surrounding environment in an autonomous way or remotely operated. This vehicle tows a trailer that permits, amongst other functions, to perform golf balls picking.

U.S. Pat. No. 9,758,305B2 entitled Robotic Navigation Utilizing Semantic Mapping discloses a method for performing tasks on items located in a space using a robot, the items being located proximate fiducial markers, each fiducial marker having a fiducial identification. The method includes receiving an order to perform a task on at least one item and determining the fiducial identification associated with the at least one item. The method also includes obtaining, using the fiducial identification of the at least one item, a set of coordinates representing a position of the fiducial marker with the determined fiducial identification, in a coordinate system defined by the space. The method further includes navigating the robot to the coordinates of the fiducial marker associated with said determined fiducial identification.

CN105833484A entitled Wireless Charging Intelligent Tennis Ball Picking Trolley And Control Method Thereof discloses a wireless charging intelligent tennis ball picking trolley and a control method thereof. The wireless charging intelligent tennis ball picking trolley mainly comprises a trolley body, an information processing unit, an information collecting unit, an executing mechanism unit, a power supply unit, a charging unit and a remote control unit. The control method of the wireless charging intelligent tennis ball picking trolley is also provided. Environment data on a tennis court is collected through the information collecting unit arranged on the intelligent trolley; the automatic ball picking and remote control ball picking of the intelligent trolley are realized by people in tennis sports. When the electricity quantity of the trolley is insufficient, the intelligent trolley can also automatically advance to the position near a set charging coil to perform wireless charging; the problems of cabled charging and short time of endurance of the trolley are solved. The intelligent trolley is tightly associated with the tennis sports, so that the pain of sportsmen due to picking of a great number of balls can be reduced; convenience is provided for the life of people.

US20050204717A1 entitled Device For Automatically Picking Up Objects discloses a system for picking up golf balls over a golf practice green consists of an automatic mobile machine equipped with a motor and a power source, for example a rechargeable battery, and provided with an onboard computer. The machine carries a mechanical device for gripping and storing the golf balls in a container, a device for emptying such container, a device for detecting the limits of the surface for picking up. The system further comprise at least a station for discharging the balls picked up and preferably a station for recharging the rechargeable batteries.

None of the above inventions and patents, taken either singly or in combination, is seen to describe the invention as claimed. Thus, a need exists for a reliable golf ball picking system and to avoid the above-mentioned problems.

### BRIEF SUMMARY OF THE INVENTION

The present golf ball picking system satisfied the needs set out above.

In one aspect, a battery-operated, unmanned ground vehicle (UGV) that can automatically pick golf balls will provide a solution that can completely replace labor involvement in such activity and thus significantly reduce labour cost in a most environmentally friendly way.

In another aspect, an unmanned ground vehicle (UGV) for picking golf balls in an outdoor environment. It is battery operated, fully automated, waterproof and can run in any weather condition and during the day and night. This can be a green and environmentally friendly solution.

In another aspect, the present invention includes a central processing unit (CPU), censor unit, motor unit, battery unit, wireless charging unit and built-in golf-balls-picking bucket that are all integrated under a waterproof shell. It also equips with a separate outdoor charging dock that charges the battery wirelessly without any exposed contact, suitable for outdoor use in any weather condition. The vehicle can be easily controlled from a mobile phone, laptop or desktop computer with real-time monitoring.

In another aspect, an autonomous golf ball picking system configured to pick up golf balls from an outdoor environment is disclosed. The system includes a route map defining a path to pick up golf balls from the ground. The route map is in a computer readable format. The system further includes an unmanned ground vehicle having a base unit having an internal ball retention compartment, a ball picking roller configured to pick up golf balls from the ground and to deposit the picked-up golf balls into the internal ball retention compartment, at least two linked wheels, each of the at least two linked wheels driven by an independent motor and configured to move the unmanned ground vehicle around the ground and an unmanned ground vehicle computer system having the capacity to read the route map and send directional instructions to the independent motors in order to drive the unmanned ground vehicle along the path set out according to the route map. In some aspects, a battery may be utilized to provide power to the unmanned ground vehicle.

In some aspects, the system may further include a docking station configured to receive the unmanned ground vehicle upon completion of picking up golf balls according to the route map. The docking station has a golf ball receiving bin configured to receive the picked golf balls from the internal ball retention compartment. Further, the docking station may have the capability to recharge the battery located within the unmanned ground vehicle. The recharging may be wireless.

The features of the invention which are believed to be novel are particularly pointed out in the specification. The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates perspective structural view of the unmanned ground vehicle according to various embodiments of the present invention described herein.

FIG. 2 illustrates the wireless charging station which is placed beside golf balls unloading pool for the unmanned ground vehicle.

FIG. 3 illustrates the mission plan design for the unmanned ground vehicle.

FIG. 4 is an exemplar flow chart of an embodiment of the operation of the present invention.

The various embodiments of the present invention will hereinafter be described in conjunction with the appended drawings, wherein like designations denote like elements.

### DETAILED DESCRIPTION

The present invention is directed to an autonomous golf ball picking system that satisfies the needs set out above.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise.

Unless otherwise defined, all terms (including technical and scientific terms) used herein have the same meaning as commonly understood by one having ordinary skill in the art to which this invention belongs.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In general, a mission plan which may include one or more route maps, which may be a series of waypoints may be designed for an autonomous golf ball picking vehicle using digital map (e.g. Google map or equivalent) and the commands to execute to one or more route maps may be created on a remote computer system. The mission plan may be subsequently programmed onto a computer system located on the vehicle. The mission plan may be directly programmed into to the vehicle's computer system or programmed on a remote computer system and subsequently transferred to the vehicle's computer system. Once the mission plan has been created and loaded onto the vehicle, connection to a computer and/or telecommunication network is no longer needed.

Further, in general, when the vehicle turned on, it may utilize a GPS system to determine the longitude and latitude of current position on the vehicle, travel to pre-defined starting position and start to run the route repeatedly collecting golf balls based on pre-defined mission plan. The CPU will track waypoints by using GPS position and compass and follow the mission plan in real time.

The mission plan may include various events and related commands to execute these events. Such events may include the time to begin and/or stop the activity of collecting balls, run the vehicle in a continuous running mode, run a first route map then a second route map, alternate between two or more route maps, etc.

An example of a mission plan may include two route maps, a first directed to golf balls that are close to the tee boxes and second for the golf balls that are located further away from the tee boxes. The mission plan may include a time schedule to run the route maps and to run the first route map for three consecutive runs then run the second route map once, then repeat the cycle. Since a majority of the golf balls will be located close to the tee boxes, the running of the first route map for three runs while the running of the second route map once will focus the effort of collecting the golf balls on the area which hold the majority of those golf balls.

When the golf ball bucket is full, a sensor can be triggered. The onboard computer system may then execute instructions to send the vehicle to a home docking station, unload the golf balls and resume the collection of golf balls automatically based on the mission plan.

The vehicle is also equipped with one or more sensors for detecting potential obstacles. While follow the mission plan, if any obstacle is detected, an object avoidance function may be triggered with a temporary detour to avoid colliding with such objects and continue following the mission plan.

The onboard computer system may monitor the battery level in real time by pre-designed trigger for low level battery. When the battery level is lower than the trigger value, the onboard computer system may send one or more commands to direct the vehicle back to a home docking station for battery recharge. When the battery is full, the vehicle may automatically return to the field by a resume mission plan command.

If the vehicle is malfunctioned or crashed, a real-time alert may be sent automatically to a home computer.

Although this invention has been described in specific detail with reference to the disclosed embodiments, it will be understood that many variations and modifications may be effected within the spirit and scope of the invention as described herein.

Although the present invention has been illustrated and described herein with reference to various embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

The present invention will now be described by referencing the appended Figures representing various embodiments.

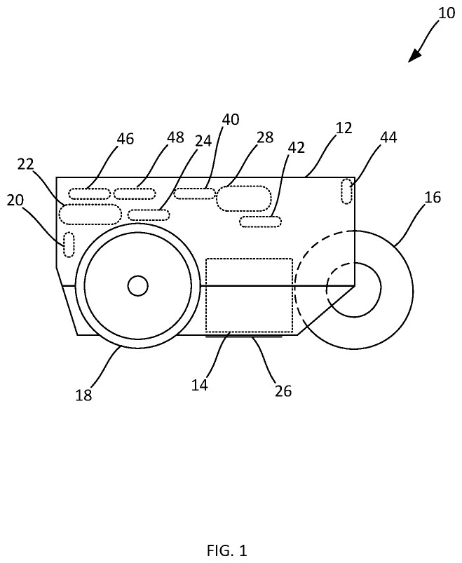

FIG. 1 illustrates perspective structural view of an unmanned ground vehicle (UGV) 10 according to various embodiments of the present invention described herein. The UGV 10 includes base unit 12, which may be substantially waterproof, having an interior ball retention compartment 14 configured to hold picked up golf balls. The UGV 10 also includes a golf ball picking roller 16 that is configured to pick up golf balls from the ground and deposit the golf balls into the ball retention compartment 14.

The UGV 10 also includes at least two linked wheels 18, each driven by an independent motor 20. The independent motors 20 allows different speeds on the each of the wheels 18 to allow for an ability to change the direction of the UGV 10. The differing speeds allow for the UGV 10 to travel in various speeds as well as travel in a reverse direction.

The UGV 10 also includes an onboard computer system 22. The onboard computer system 22 may include a processor and a computer readable storage medium having computer readable instructions stored thereon for execution by the processor. The onboard computer system 22 is configured to store and execute programs and commands that allow the UGV 10 to autonomously pick up and drop off golf balls.

A motor driver 24 is connected to the onboard computer system 22 and to the independent motors 20 which controls the speed of the wheels 18.

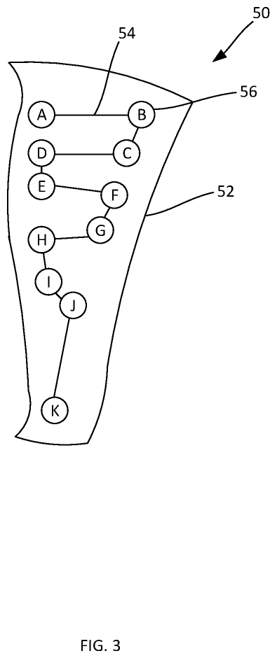

FIG. 3 illustrates an exemplarily route map 50 according to embodiments of the present invention. The route map 50 is set in an outdoor environment 52 and can be a field or other location that is used as a golf driving range or similar activity. The route map 50 may include one or more waypoints 56 and marked as A-K in FIG. 3. A path 54 is set out between the various waypoints. The creation of the route map 50 may be performed remotely from the UGV 10 utilizing various techniques and resources. For example, a route map may be characterized by way points in the field by predesigned geographic longitude and latitude using digital map (e.g. Google Map). The route map 50 may be uploaded to the UGV 10 so that the UGV 10 may operate autonomously. In operation, the unmanned ground vehicle 10 may follow path 54 from waypoint 56 to waypoint. For example, the unmanned ground vehicle 10 may start at waypoint A, follow path 54 to waypoint B and then to waypoint C.

The route map 50 may be a computer readable file that can be processed and acted upon by the onboard computer system 22. Accordingly, the onboard computer system 22 is configured to read the route map and send directional instructions to the independent motors in order to drive the unmanned ground vehicle along the path set out according to the route map.

In some embodiments, it may be desirable to have the UGV 10 follow multiple route maps or the same route map multiple times. To accommodate this situation, a mission plan may be utilized. A mission plan may be a plan that includes one or more route maps.

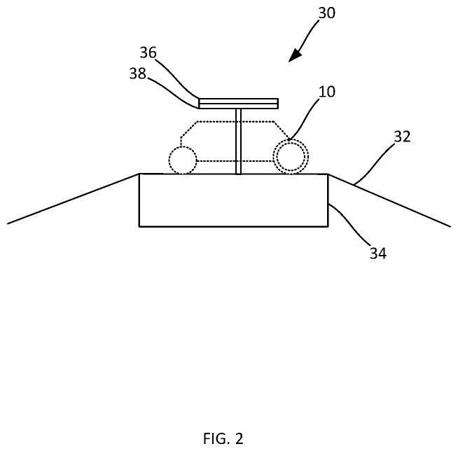

FIG. 2 illustrates a docking station 30 configured to receive the unmanned ground vehicle 10 upon completion of picking up golf balls according to the route map. The docking station 30 may have a receiving ramp 32 and a golf ball receiving bin 34 configured to receive the picked golf balls from the interior ball retention compartment 14.

In some embodiments, the base unit 12 may include an access door 26 configured to allow access into the internal ball retention compartment 14 to allow the picked-up golf balls to be deposited into the golf ball receiving bin 34 within the docking station 30. The access door 26 may be any suitable door, including a magnetically operated door. Further, the opening and closing of the access door 26 may be controlled by the onboard computer system 22 or other computer system to further ensure these embodiments are automated.

In some embodiments, the unmanned ground vehicle 10 may include a rechargeable battery 28 configured to provide power to the unmanned ground vehicle 10. In these embodiments, the unmanned ground vehicle 10 may also include at least one battery sensor 40 to determine the power level of the battery 28. In these embodiments, the onboard computer system 22 is configured to send directional instructions to the independent motors 20 through the motor driver 24 in order to drive the unmanned ground vehicle to the docking station when the at least one battery sensor 40 determines the power level of the battery 28 dropped below a specific power threshold. Further in these embodiments, docking station 30 will further includes a battery charging component 36 configured to recharge the rechargeable battery 28 within the unmanned ground vehicle 10 either wirelessly or through a physical contact. Battery charging component 36 may be one or more solar panels, one or more batteries or connected to a remote power grid.

In some embodiments, the unmanned ground vehicle 10 may further include at least one ball capacity sensor 42 to determine the capacity level of the internal ball retention compartment 14. In these embodiments, the onboard computer system 22 is configured to send directional instructions to the independent motors 20 through the motor driver 24 in order to drive the unmanned ground vehicle to the docking station when the at least one ball capacity sensor 42 determines the capacity of the internal ball retention compartment 14 has reached a maximum capacity.

In some embodiments, the docking station 30 may further include a docking station computer system 38 having docking station processor and a docking station computer readable storage medium having computer readable instructions stored thereon for execution by the docking station processor. In these embodiments, the docking station computer system 38 is configured to transmit and receive data and instructions to and from the unmanned ground vehicle. For example, the docking station computer system 38 may communicate with the unmanned ground vehicle 10 in order to have the access door 26 open in order to have the picked up golf balls be deposited from the interior ball retention compartment 14 to the golf ball receiving bin 34.

In some embodiments, the unmanned ground vehicle 10 may include at least one obstacle avoidance sensor 44 configured to detect obstacles within the path of the unmanned ground vehicle 10. In these embodiments, the onboard computer system 22 is configured to send directional instructions to the independent motors 20 through the motor driver 24 in order to drive the unmanned ground vehicle 10 in a modified path to avoid any detected obstacles.

In some embodiments, the UGV 10 may include a GPS location system 48 to assist the UGV 10 in locating it position within the route map 50.

In some embodiments, two or more UGVs 10 and/or two or more docking stations 30 may be utilized. In these embodiments, two or more UGVs 10 may utilized a single docking station 30. This will allow for multiple UGVs to be in operation simultaneously. Further, one UGV 10 may utilize two or more docking stations 30. This will allow for multiple options for the depositing of picked-up golf balls and for the recharging of the battery 28 of the UGV 10.

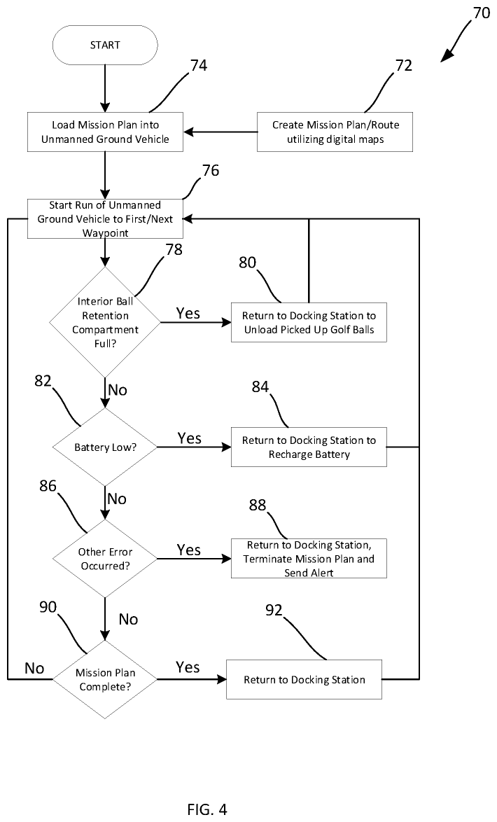

FIG. 4 illustrates a decision a flow chart 70 of an embodiment of the operation of the present invention. Upon the start of the operation, a mission plan containing one or more route maps is created remotely from a UGV 72. The mission plan is then uploaded into the UGV 74.

Upon the loading of the mission plan, the UGV sets out to pick up golf balls from the ground by heading to a first waypoint pursuant to the route map 76. This is referred to starting a run.

During this run, the UGV will inquire if the interior ball retention compartment is full 78. If so, instructions from the onboard computer system will direct the UGV to the docking station to unload the interior ball retention compartment 80. The UGV will begin and/or continue with the current run pursuant to the route map 76.

Additionally, during this run, the UGV will inquire if the UGV's battery is low on power 82. If so, instructions from the onboard computer system will direct the UGV to the docking station in order to recharge the battery 84. Upon the recharge of the battery, the UGV will begin and/or continue with the current run pursuant to the route map 76.

Still further, during this run, the UGV will inquire if any other errors are detected 86. If so, instructions from the onboard computer system will direct the UGV to the docking station where the mission plan will be terminated and where the UGV will be transmitted an alert to notify an operator of the error. This transmitted alert can be audible, over a telecommunication network or other similar manner.

Still further, during this run, the UGV will inquire if the mission plan is complete 90. If so, instructions from the onboard computer system will direct the UGV to the docking station for unloading of the picked-up golf balls and for storage 92. If not, the UGV will begin and/or continue with the current run pursuant to the route map 76.

The exact specifications, materials used, and method of use of the autonomous golf ball picking system may vary upon manufacturing.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment(s) were chosen and described in order to best explain the principles of the present invention and its practical application, to thereby enable others skilled in the art to best utilize the present invention and various embodiments with various modifications as are suited to the particular use contemplated.

What is claimed is:

1. An autonomous golf ball picking system configured to pick up golf balls from an outdoor environment, the system comprising:
a route map defining a path to pick up golf balls from the ground, the route map being in a computer readable format;
an unmanned ground vehicle having
a base unit having an internal ball retention compartment,
a ball picking roller configured to pick up golf balls from the ground and to deposit the picked-up golf balls into the internal ball retention compartment,
at least two linked wheels, each of the at least two linked wheels driven by an independent motor and configured to move the unmanned ground vehicle around the ground; and
an unmanned ground vehicle computer system having
a processor and a computer readable storage medium having computer readable instructions stored thereon for execution by the processor, causing the processor to:
read the route map and send directional instructions to the independent motors in order to drive the unmanned ground vehicle along the path set out according to the route map.

2. The system of claim 1, further comprising:
a docking station configured to receive the unmanned ground vehicle upon completion of picking up golf balls according to the route map, the docking station having a golf ball receiving bin configured to receive the picked golf balls from the internal ball retention compartment.

3. The system of claim 2, wherein the base unit of the unmanned ground vehicle further comprises an access door configured to allow access into the internal ball retention compartment, the access door configured to open to allow the picked-up golf balls to be deposited into the golf ball receiving bin within the docking station.

4. The system of claim 2, wherein the unmanned ground vehicle further comprises
a rechargeable battery configured to provide power to the unmanned ground vehicle; and
and at least one battery sensor to determine the power level of the battery, and
wherein the processor and a computer readable storage medium having computer readable instructions stored thereon for execution by the processor, causing the processor to:
send directional instructions to the independent motors to in order to drive the unmanned ground vehicle to the docking station when the at least one battery sensor determines the power level of the battery dropped below a specific power threshold, and
wherein the docking station further includes a battery charging component configured to recharge the rechargeable battery within the unmanned ground vehicle.

5. The system of claim 2, wherein the unmanned ground vehicle further comprises
and at least one ball capacity sensor to determine the capacity level of the internal ball retention compartment, and
wherein the processor and a computer readable storage medium having computer readable instructions stored thereon for execution by the processor, causing the processor to:
send directional instructions to the independent motors to in order to drive the unmanned ground vehicle to the docking station when the at least one ball capacity sensor determines the capacity of the internal ball retention compartment has reached a maximum capacity.

6. The system of claim 2, wherein the docking station further comprises:
a docking station computer system a docking station processor and a docking station computer readable storage medium having computer readable instructions stored thereon for execution by the docking station processor, causing the docking station processor to:
transmit and receive data and instructions to and from the unmanned ground vehicle.

7. The system of claim 1, wherein the base unit of the unmanned ground vehicle is substantially water-proof.

8. The system of claim 1, wherein the unmanned ground vehicle further comprises:
at least one obstacle avoidance sensor configured to detect obstacles within the path of the unmanned ground vehicle, and
wherein the processor and a computer readable storage medium having computer readable instructions stored thereon for execution by the processor, causing the processor to:
send directional instructions to the independent motors to in order to drive the unmanned ground vehicle in a modified path to avoid any detected obstacles.

9. The system of claim 1, wherein the unmanned ground vehicle is an all-terrain vehicle.
